(19) United States
(12) Patent Application Publication
(10) Pub. No.: US 2018/0064280 A1
(43) Pub. Date: Mar. 8, 2018

(54) CONTROL OF THE HEATING OF A HOUSEHOLD APPLIANCE VIA VIRTUAL TEMPERATURE

(71) Applicant: Miele & Cie. KG, Guetersloh (DE)

(72) Inventors: Michael Junkmann, Rietberg (DE); Marco Lyttek, Lonsee (DE)

(21) Appl. No.: 15/694,880

(22) Filed: Sep. 4, 2017

(30) Foreign Application Priority Data
Sep. 6, 2016 (DE) 10 2016 116 598.0

(51) Int. Cl. A47J 27/00; A47J 37/00

(52) U.S. Cl. CPC A47J 27/002; A47J 37/00

(57) ABSTRACT

A method for controlling heating of a region to be heated of a household appliance includes: a) activating the heating; b) providing a starting temperature value Cₛ; c) extrapolating a virtual temperature Cᵥ of the region to be heated over time, beginning from the starting temperature value Cₛ and based on a characteristic heating curve; d) continuously measuring real temperature values Cₘ representing the temperature of the region to be heated, using a single temperature sensor; e) continuing with step b) using the current temperature value Cₘ as the starting temperature value Cₛ if the difference between two successive temperature values Cₘ indicates a normal condition of the temperature sensor; and f) deactivating the heating if the difference between the two successive temperature values Cₘ indicates a fault condition of the temperature sensor and the virtual temperature Cᵥ exceeds a threshold.

### CROSS-REFERENCE TO PRIOR APPLICATION

Priority is claimed to German Patent Application No. DE 10 2016 116 598.0, filed on Sep. 6, 2016, the entire disclosure of which is hereby incorporated by reference herein.

### FIELD

The present invention relates to a method for controlling the heating of a household appliance using a virtual temperature of a region to be heated, as well as to a household appliance which operates in accordance with the method, in particular a cooking appliance.

### BACKGROUND

Household appliances having heating means are required to have a high-temperature cutoff because of safety considerations. The temperature of the region to be heated is measured by a temperature sensor, and in case of overheating, the heating is cut off. However, temperature sensors can fail, especially those exposed more or less directly to high temperatures. In order to nevertheless assure a reliable cutoff, redundancy may be provided in the form of an additional temperature sensor.

However, generally, additional components are a disadvantage because they make the appliance more expensive. Furthermore, an additional sensor requires corresponding wiring, and the evaluation electronics must also be designed accordingly. Additional space is needed which, in the case of an otherwise predetermined appliance size, is then not available for other components or as usable space.

A purely sensor-based control system can only work properly when the measured values are reliable. However, the additional sensor may generally fail or break down for the same reasons as the first sensor, so that there is a possibility that incorrect measurement values may not be detected even when redundant sensors are present. The household appliances known in the art do not have a feature for checking the plausibility of measured values.

### SUMMARY

In an embodiment, the present invention provides a method for controlling the heating of a region to be heated of a household appliance, the method comprising: a) activating the heating; b) providing a starting temperature value Cₛ; c) extrapolating a virtual temperature Cᵥ of the region to be heated over time, beginning from the starting temperature value Cₛ and based on a characteristic heating curve; d) continuously measuring real temperature values Cₘ representing the temperature of the region to be heated, using a single temperature sensor; e) continuing with step b) using the current temperature value Cₘ as the starting temperature value Cₛ if the difference between two successive temperature values Cₘ indicates a normal condition of the temperature sensor; and f) deactivating the heating if the difference between the two successive temperature values Cₘ indicates a fault condition of the temperature sensor and the virtual temperature Cᵥ exceeds a threshold.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows characteristic curves of a heating system of a household appliance according to an embodiment;

FIG. 2 shows a flow chart of a method according to an embodiment; and

FIG. 3 shows temperature profiles over time in an inventive household appliance according to an embodiment.

### DETAILED DESCRIPTION

In an embodiment, the present invention provides a method for controlling the heating of a region to be heated of a household appliance, the method including:

b) providing a starting temperature value Cₛ;
c) extrapolating a virtual temperature Cᵥ of the region to be heated over time, beginning from the starting temperature value Cₛ and based on a characteristic heating curve;
d) continuously measuring real temperature values Cₘ representing the temperature of the region to be heated, using a single temperature sensor;
e) continuing with step b) using the current temperature value Cₘ as the starting temperature value Cₛ if the difference between two successive temperature values Cₘ indicates a normal condition of the temperature sensor; and
f) deactivating the heating if the difference between the two successive temperature values Cₘ indicates a fault condition of the temperature sensor and the virtual temperature Cᵥ exceeds a threshold.

In accordance with the present invention, a fault condition is detected when the measured temperature exhibits an unexpected behavior for the active heating setting. In this context, “expected behavior” would be understood to mean that, with the heating active, an increase by at least a difference of, for example, 2° C., is to be expected. “Unexpected behavior” can mean that the temperature sensor is not measuring correctly, and thus that the real temperature in the region to be heated deviates from the measured temperature and, especially, is higher than the measured temperature.

If heating were continued under these conditions, the household appliance could be damaged due to excessively high temperatures, or excessively high temperatures could result in failure to meet normative requirements, for example, because a touchable surface gets too hot. However, a premature cutoff due to the unexpected temperature behavior would be disadvantageous because this would reduce availability. On the one hand, there may be reasons for the unexpected behavior that are not due to a defect, so that it would be unnecessary to perform a cutoff to protect the appliance. For example, loading a cooking appliance with frozen food may result in an unexpected behavior which, however, is not critical in this case.

On the other hand, it can be assumed that the temperature sensor was measuring correctly until the unexpected behavior occurred, and that the household appliance or the region to be heated was in a normal, non-critical temperature range. Usually, depending on the heat output and/or the thermal inertia of the region to be heated, the heating will require a certain amount of time to heat the household appliance or the region to be heated to critical temperatures, so that this period of time can be used to delay the cutoff without impairment of safety. This makes it possible to increase availability.

The virtual temperature continues to be extrapolated in parallel. If, prior to reaching the threshold, the measure temperature exhibits an expected behavior again, it is assumed that the temperature sensor is measuring correctly and the virtual temperature is set to the last measured value and is further extrapolated, beginning from this value. However, if the virtual temperature exceeds a threshold while the fault condition is present; i.e., if the measured temperature exhibits an unexpected behavior, the heating is switched off to prevent damage to the household appliance. The threshold may be derived based on normative requirements and/or appliance safety requirements.

The starting value may, for example, be selected to take into account that when the household appliance is switched on, the household appliance or the region to be heated may still be hot, for example, from a previous cooking operation. Therefore, the initial starting value is preferably set to just below the threshold upon switching on the household appliance.

The method according to the present invention makes it possible to employ only one temperature sensor for monitoring the heating process. Despite the fact that no additional, redundant temperature sensors are used, it is possible to achieve at least equivalent, or even improved levels of reliability and safety of operation. This makes it possible to reduce the cost of a correspondingly constructed household appliance, and also to reduce the number of components that are potentially subject to defects.

Direct measuring temperature sensors located near or even in the region to the heated, especially, are exposed to high loads resulting from high temperatures, and thus are potentially prone to defects. The high temperature resistance required for the temperature sensors makes them costly, which is why a reduction in the number of sensors has a particularly positive effect in this respect.

Alternatively or additionally, the heating may also be interrupted when the virtual temperature exceeds the threshold between two measurements of temperatures Cₘ. If the next temperature value Cₘ indicates a normal behavior, the heating may be reactivated.

In a specific embodiment,

in step e), a normal condition of the temperature sensor is detected if the difference between the two successive temperature values Cm is at least equal to a minimum heating gradient;
and, in step f), a fault condition of the temperature sensor is detected if the difference between the two successive temperature values Cₘ is less than the minimum heating gradient.

The measured temperature values are then checked for plausibility, taking into account an expected behavior during heating operation. During heating operation of the household appliance, an increase in temperature should be observable under normal conditions. As long as the measured temperature value increases according to a minimum gradient, normal functioning can be assumed. It is preferred to use, as a requirement for this, a temperature difference that is greater than the system tolerances and therefore yields a real new measurement value. However, as soon as the temperature value exhibits no or loo low a heating gradient, a fault can be inferred therefrom.

A possible reason for such behavior may be that the temperature sensor is measuring incorrectly. In the case of a household appliance having a cooking chamber, another reason may be that the cooking chamber door has been opened or left open. In these cases, the heating means cannot heat the cooking chamber at the same rate as when the cooking chamber door is closed, or the temperature may decrease even if the heating is active. It is also conceivable that the heating system has a defect that prevents it from heating even when activated. In accordance with the present invention, in the case of such faults, a fault condition is detected based on the behavior of the temperature.

However, in accordance with the present invention, in order to prevent an excessively jumpy control behavior, the cutoff is made dependent on the virtual temperature as well. This prevents an unnecessary cutoff from occurring, for example when a cooking chamber door of a cooking appliance is opened briefly. Such behavior would be incomprehensible to the user of the household appliance. Moreover, the cooling would thereby be further increased, so that, even after closing the cooking chamber door, a longer period of time would pass until the heating would be reactivated due to increasing temperature.

In a specific embodiment,

the heating system has an adjustable heat output and one or more adjustable heating modes; and
the characteristic curve is a temperature profile over time of the region to be heated, which is dependent on the heating setting.

The setting of the heating system may cause a different heating behavior of the region to be heated. For example, a baking oven is known to have the following heating modes: bottom heat and/or top heat, ring heating element, grill, and combinations thereof, in each case with or without air convention. The position of the single temperature sensor relative the respective active heating elements differs depending on the heating mode. Also, depending on the heating mode, the heated medium will distribute itself and propagate differently over time. For example, during convection mode operation, the distribution occurs faster and more uniformly than in bottom heat mode.

Furthermore, the temperature profile over time of the region to be heated will depend on the heat output setting. If the selected setpoint temperature influences the heating mode and/or the heat output, the setpoint temperature may also influence the heating gradient. For example, additional heating elements may be briefly activated for high setpoint temperatures, whereas this does not occur in the case of low setpoint temperatures.

The heating behavior expected for a particular heating setting can be taken into account by means of a characteristic curve that indicates an expected temperature profile over time of the region to be heated for a particular combination of the possible parameters, which are setpoint temperature, heat output and heating mode. The characteristic curve needs to be determined only once for an appliance series and can then be used for all appliances of the series to enable extrapolation of the virtual temperature.

In a simplified alternative, instead of using a plurality of characteristic curves which are each derived from measured real temperature profiles, it is also possible to use only one combined characteristic curve. A combined characteristic curve could be derived, for example, from the respective highest temperatures or highest increases in temperature. Then, a “worst case” consideration would be performed, which would always assume the highest measured increase in temperature for the extrapolation of the virtual temperature.

In a specific embodiment, the minimum heating gradient is constant or dependent on the heating setting and on the previous value Cₘ.

For example, the minimum heating gradient between two temperature measurements may be 2° C. Alternatively, analogously to the recording of the characteristic curve for the virtual temperature, a characteristic curve may be determined for the expected minimum temperature profile over time for a given heating setting. The minimum heating gradient must then always be at least as high as derived from this characteristic curve, starting from the actual temperature. Preferably, the previous value of the measured temperature Cₘ may be used the actual temperature.

In a specific embodiment, the method further includes:

g) deactivating the heating if the difference between the two successive temperature values Cₘ indicates a fault condition of the temperature sensor and virtual temperature Cᵥ does not exceed the threshold, but does exceed a warning value which is lower than the threshold; and
h) reactivating the heating and continuing with step b) after a predetermined limited period of time.

In this embodiment, the availability of the heating can be increased because a cutoff lasts only for a limited period of time, after which the heating is automatically reactivated, without the temperature sensor already having to exhibit a normal behavior again. A preferred value for the period of time is 2-15 minutes. However, because of safety considerations, this is preferably done only a limited number of times, most preferably only once, after the appliance has been powered on or after the heating has been activated for the first time after power-on. In an exemplary embodiment, in the warning range; i.e., when a fault occurs for the first time, the system waits 15 minutes (for a decreasing temperature difference) with the heating off before a new attempt is made; i.e., the heating is reactivated. If, thereafter, a fault occurs again; i.e., if the virtual temperature exceeds the threshold temperature again, a permanent cutoff is effected.

In a specific embodiment, the method further includes, after deactivating the heating in step f):

f) reactivating the heating and continuing with step b) using the current temperature value Cₘ as the starting value if the difference between two successive temperature values Cₘ indicates a normal condition of the temperature sensor.

If, after the heating has been deactivated because of a detected fault condition of the temperature sensor, an expected temperature change is measured again, it can be assumed that the temperature sensor is measuring correctly. Therefore, the fault condition is cancelled and the heating is reactivated.

In a specific embodiment, in step f), a normal condition of the temperature sensor is detected if the difference between the two successive temperature values Cₘ is at least equal to a minimum cooling gradient.

In a specific embodiment, the minimum cooling gradient is constant or is derived from a characteristic cooling curve of the region to be heated.

The minimum cooling gradient may be constant, for example 2° C. Alternatively, analogously to the recording of the characteristic curve for the virtual temperature, a characteristic curve may be determined for the expected temperature profile over time during cooling of a given region to be heated. The minimum cooling gradient must then always be as high as derived from this characteristic curve, or, in other words, the cooling must be at least of the same magnitude.

In a specific embodiment, the extrapolation of the virtual temperature Cᵥ is in each case performed after a first time interval, and the measurement of the real temperature values Cₘ is in each case performed after a second time interval, the first time interval preferably being shorter than the second time interval.

The first time interval can be selected to be relatively short because it concerns a virtual temperature that does not require a measurement operation. Therefore, the time interval can be selected, for example, according to the available processing power of the controller of the appliance and/or according to the desired time resolution. The time interval should not be shorter than the time resolution of the characteristic curve.

The second time interval, in turn, cannot be arbitrarily short because it concerns a real measurement operation which, inter alia, must take thermal inertias into account. Moreover, it should selected to be at least as long as the first time interval. On the other hand, it should be short enough that no overheating can occur between two measurement points in time during maximum expected heating of the appliance if the temperature at the first measurement point in time was still within the tolerance.

The first time interval is preferably shorter than the second time interval; i.e., the virtual temperature has a finer resolution than the real temperature measured by the temperature sensor.

A second aspect provides a household appliance comprising:

a heating system for heating a region to be heated, the heating system having an adjustable heat output and one or more adjustable heating modes;
a controller for controlling the heating system, the controller being adapted to control the heating system according to the setting; and
a single temperature sensor adapted to measure a temperature value Cₘ representing the temperature of the region to be heated;
the controller being adapted to perform a method as described above.

In a specific embodiment, the household appliance includes a cooktop, and the region to be heated is a cooking zone of the cooktop and/or a cooking vessel located on the cooking zone.

For example, in the case of gas or radiant heat cooktops, the region to be heated is the cooking zone itself, whereas in the case of induction cooktops, the cooking zone and an induction-capable cooking vessel together form the region to be heated.

In a specific embodiment, the household appliance includes a cooking chamber which forms the region to be heated.

In the case of built-in appliances such as baking ovens, microwave ovens, steam cookers or warming drawers, the region to be heated forms part of the appliance itself.

In a specific embodiment, the single temperature sensor is a direct measuring temperature sensor which is located in or adjacent to the region to be heated.

The temperature sensor may be, for example, a PT1000 sensor which is located in the region to be heated or adjacent thereto. In the example of a cooking appliance having a cooking chamber, the temperature sensor may be disposed inside the cooking chamber or on the outer side of a cooking chamber wall.

In an alternative embodiment, the single temperature sensor is an indirect measuring temperature sensor which is located remotely from the region to be heated. In the example of a cooktop, the temperature sensor may be, for example, an infrared sensor which measures the infrared radiation from the bottom of a cooking vessel, and thus, determines the temperature of the region to be heated indirectly.

In a specific embodiment, the household appliance is a cooking appliance which is one or a combination of the following:

cooktop;
baking oven;
microwave oven;
steam cooker;
warming drawer.

A third aspect provides a computer program adapted to perform a method as described above when executed on the controller of a household appliance as described above.

Exemplary embodiments of the present invention are shown in the drawings in a purely schematic way and will be described in more detail below. Features of different embodiments may be combined arbitrarily, unless otherwise indicated.

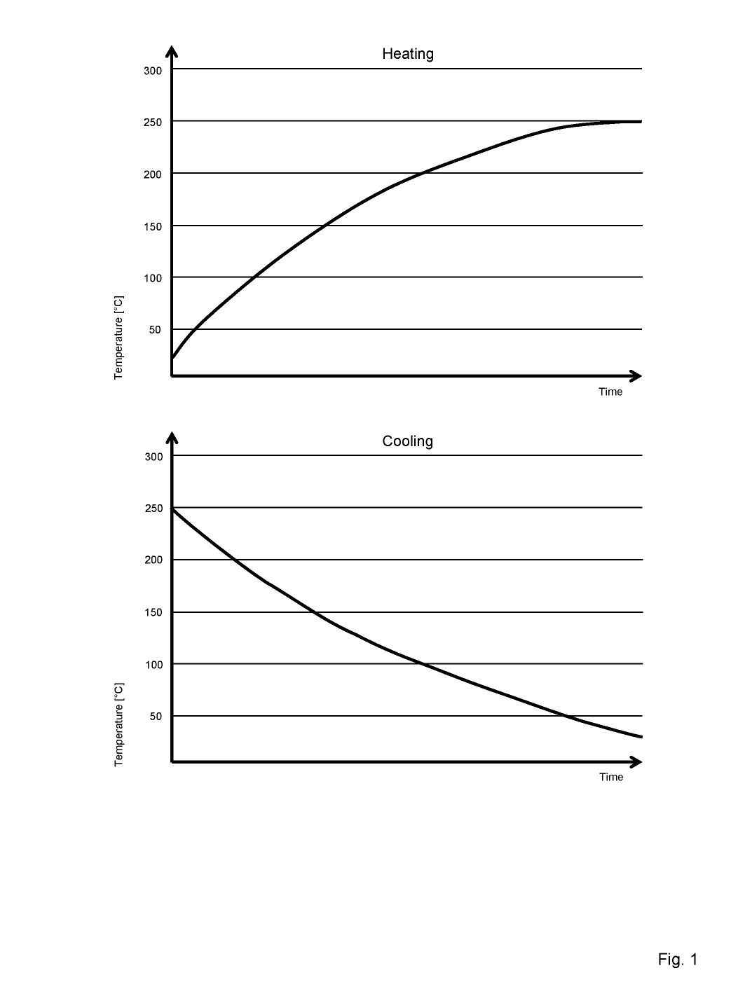

FIG. 1 shows characteristic curves for temperature profiles over time during a heating process and a cooling process according to an embodiment. These characteristic curves can be used in accordance with the present invention to extrapolate the virtual temperature. The characteristic curves can be determined by performing measurements on an appliance and can then be used for appliances of identical design. The characteristic curves may directly correspond to the measured profiles or be derived therefrom by suitable means, smoothing, maximum/minimum value calculation, inter/extrapolation, approximation or generation of an envelope.

The curves depicted here show non-linear profiles, as will generally occur in practice. For a given heat output, the slope of the temperature curve during heating will decrease with increasing temperature. Conversely, for a given region to be heated having a given geometry and thermal insulation, such as, for example, the cooking chamber of a baking oven or another cooking appliance, the slope will decrease during cooling as the temperature decreases or approaches room temperature.

If the household appliance has more than one heating mode, it is possible either to determine a respective characteristic curve for each operational mode. For example, the temperature profile over time will differ between the known heating modes: bottom heat and/or top heat, ring heating element, grill, and combinations thereof, in each case with or without air convention. However, it may be sufficient to perform an averaging or maximum value calculation between all possible profiles to determine a combined characteristic curve. In the case of real temperature profiles that do not differ very much, a linear approximation may be sufficient to derive a suitable characteristic curve.

What matters for the cooling process when the heating is deactivated is essentially the thermal properties of the region to be heated. Generally, therefore, a single characteristic cooling curve may be sufficient. However, cooling may in some cases be influenced by active fans, such as in baking ovens, for example in certain temperature ranges. In such case, the characteristic curve must account for this.

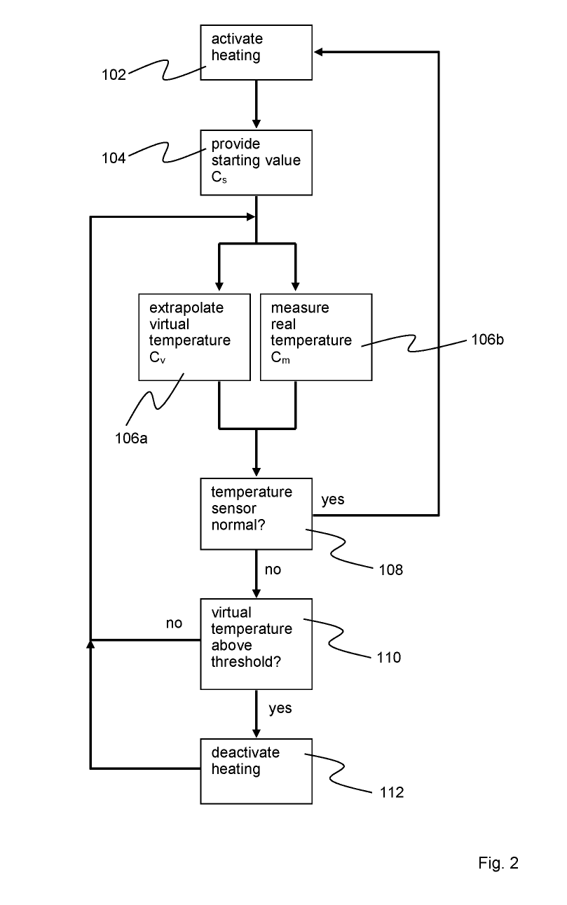

FIG. 2 shows a flow diagram of an embodiment of a method in accordance with the present invention. The heating is activated in step 102. In step 104, a starting value Cₛ is provided for the extrapolation of the virtual temperature. This may be a measured temperature value, but preferably it is an initial input value, for example a value between a warning temperature and a cut-off temperature of the household appliance.

Following, independently of each other, a virtual temperature is extrapolated, on the one hand, and, on the other hand, a real temperature of the region to be heated is measured. This does not necessarily have to take place in identical time intervals or at identical points in time. Preferably, the virtual temperature is determined at least as often as, or more frequently than, the real temperature.

In step 106a, a virtual temperature Cᵥ is extrapolated. This means that, beginning from the starting value Cₛ provided in step 104, a virtual temperature of the region to be heated is determined based on a characteristic curve available for the selected heating mode and setting (such as, for example. the heating curve shown in FIG. 1). In step 106b, a real temperature Cₘ is measured in parallel by a temperature sensor of the household appliance.

In step 108, it is checked whether the temperature sensor exhibits a normal behavior. In accordance with the present invention, a “normal behavior” is understood to be a sufficient upward or downward change in temperature. Depending on whether or not the heating is active, the region to be heated is expected to heat up or cool down. Therefore, for normal behavior, there must be a minimum difference between two successively measured real temperature values Cₘ. This difference may have a constant value, for example 2° C., or may depend on the heating setting and the actual temperature. In this connection, it is preferably possible to use the previously measured temperature value Cₘ as the actual temperature.

If, in step 108, it is determined that the temperature sensor is operating normally, the method continues with step 102. In this connection, if the heating is already active while this step is being performed, the term “activating the heating” is accordingly understood to mean that the heating is kept active. Further, in subsequent step 104, the last measured value Cₘ is used as a new starting value Cₛ.

If, in step 108, it is determined that the temperature sensor is not operating normally, it is checked in step 110 whether the virtual temperature exceeds a threshold. If this is not the case, the method continues with steps 106a and 106b. Therefore, no new starting value Cₛ is provided for the virtual temperature. Thus, as long as the temperature sensor is not operating normally, but the virtual temperature Cᵥ remains below the threshold, the method is continued with the heating activated.

If, in step 110, it is determined that the virtual temperature Cᵥ exceeds the threshold, the heating is deactivated in step 112. Thereafter, the method continues with steps 106a and 106b, with the virtual temperature Cᵥ now being extrapolated for the case of cooling. Thus, in step 108, a normal behavior of the temperature sensor is now given if the measured temperature decreases sufficiently. As soon as this is the case, the method continues by activating the heating in step 102 and providing a new starting value in step 104, with the starting value Cₛ being set to the last measured value Cₘ.

In another specific embodiment, a further check may be provided after step 110 if the virtual temperature Cᵥ still remains below the threshold. It is then checked whether the virtual temperature Cᵥ is above a warning value which is below the threshold. If this is the case, the heating is deactivated. After a predetermined period of time, the method automatically continues with step 102; i.e., the heating is reactivated without requiring that the temperature sensor exhibit a normal behavior. This increases the availability of the heating. However, this is preferably done only once per ON/OFF cycle of the household appliance.

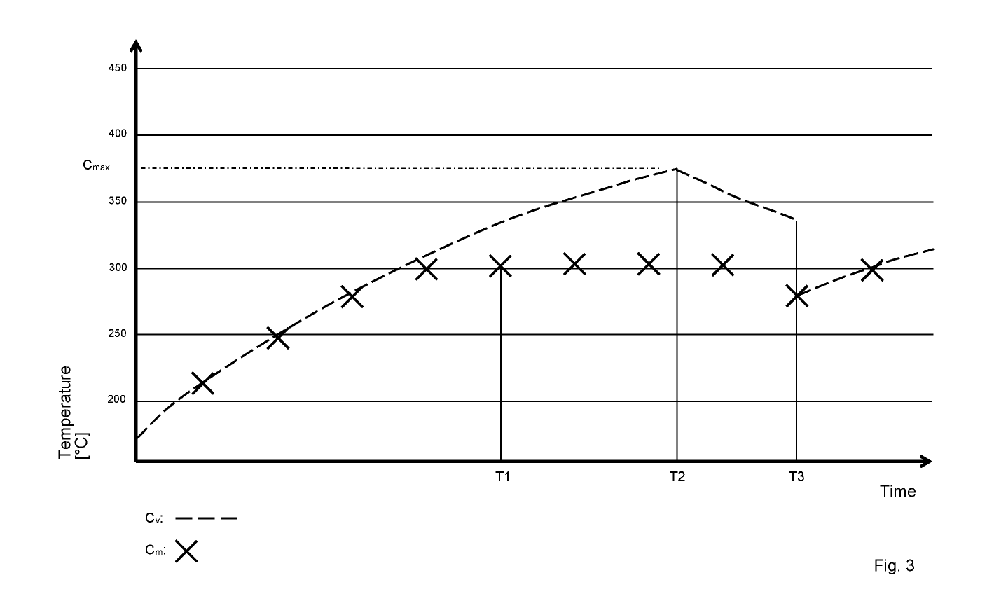

FIG. 3 shows a temperature profile over time in an inventive household appliance according to an embodiment. The temperature values shown are merely illustrative. A heating process of the household appliance starts at a (virtual) temperature of about 170° C. The virtual temperature Cᵥ is here represented by a dashed curve. The extrapolation of the virtual temperature may be performed quasi-continuously, depending on how many data points the underlying characteristic curve has. The real temperature Cₘ is measured at regular intervals, here represented as crosses.

At time T1, the measured temperature Cₘ exhibits only a minimum temperature increase relative to the previous value. The measured temperature remains approximately constant at about 300° C. From T1 on, the appliance is in a fault condition because an abnormal behavior of the temperature sensor can be assumed. In the case that the measured temperature decreases even if the heating is active, the procedure would be analogous.

At a time T2, the virtual temperature, which is extrapolated independently of the measured temperature, has exceeded a threshold Cₘₐₓ. Therefore, the heating is cut off. From T2 on, the virtual temperature is extrapolated according to the associated characteristic cooling curve.

At time T3, the measured temperature exhibits a decrease relative to the previous value. Since this decrease is at least equal to the expected cooling gradient, it is assumed that the temperature sensor is operating normally again. Therefore, the heating is reactivated and a new starting value, which corresponds to the last measured value Cₘ, is provided for the virtual temperature.

Between the start and T1, the appliance is in a normal condition; between T1 and T2, it is in a fault condition with the heating activated; between T2 and T3, it is in a fault condition with the heating deactivated; and from T3 on, it is in a normal condition again.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A method for controlling the heating of a region to be heated of a household appliance, the method comprising:
a) activating the heating;
b) providing a starting temperature value Cₛ;
c) extrapolating a virtual temperature Cᵥ of the region to be heated over time, beginning from the starting temperature value Cₛ and based on a characteristic heating curve;
d) continuously measuring real temperature values Cₘ representing the temperature of the region to be heated, using a single temperature sensor;
e) continuing with step b) using the current temperature value Cₘ as the starting temperature value Cₛ if the difference between two successive temperature values Cₘ indicates a normal condition of the temperature sensor; and
deactivating the heating if the difference between the two successive temperature values Cₘ indicates a fault condition of the temperature sensor and the virtual temperature Cᵥ exceeds a threshold.

2. The method as recited in claim 1, wherein:
in step e), a normal condition of the temperature sensor is detected if the difference between the two successive temperature values Cₘ is at least equal to a minimum heating gradient; and
in step f), a fault condition of the temperature sensor is detected if the difference between the two successive temperature values Cₘ is less than the minimum heating gradient.

3. The method as recited in claim 2, wherein:
the heating system has an adjustable heat output and one or more adjustable heating modes; and
the characteristic curve is a temperature profile over time of the region to be heated, which is dependent on the heating setting.

4. The method as recited in claim 3, wherein the minimum heating gradient is constant or dependent on the heating setting and on the actual temperature of the region to be heated.

5. The method as recited in claim 1, further comprising:
g) deactivating the heating if the difference between the two successive temperature values Cₘ indicates a fault condition of the temperature sensor and the virtual temperature Cᵥ does not exceed the threshold, but does exceed a warning value which is lower than the threshold; and
h) reactivating the heating and continuing with step b) after a predetermined limited period of time.

6. The method as recited in claim 1, further comprising, after deactivating the heating in step f):
f) reactivating the heating and continuing with step b) using the current temperature value Cₘ as the starting value if the difference between two successive temperature values Cₘ indicates a normal condition of the temperature sensor.

7. The method as recited in claim 6, wherein:
in step f), a normal condition of the temperature sensor is detected if the difference between the two successive temperature values Cₘ is at least equal to a minimum cooling gradient.

8. The method as recited in claim 7, wherein the minimum cooling gradient is constant or is derived from a characteristic cooling curve of the region to be heated.

9. The method as recited in claim 1, wherein the extrapolation of the virtual temperature Cᵥ is in each case performed after a first time interval, and the measurement of the real temperature values Cₘ is in each case performed after a second time interval, the first time interval preferably being shorter than the second time interval.

10. A household appliance comprising:
a heating system for heating a region to be heated, the heating system having an adjustable heat output and one or more adjustable heating modes;
a controller for controlling the heating system, the controller being adapted to control the heating system according to the setting; and
a single temperature sensor adapted to measure a temperature value Cₘ representing the temperature of the region to be heated,
wherein the controller is adapted to perform a method for controlling the heating of a region to be heated of a household appliance, the method comprising:
a) activating the heating;
b) providing a starting temperature value Cₛ;
c) extrapolating a virtual temperature Cᵥ of the region to be heated over time, beginning from the starting temperature value Cₛ and based on a characteristic heating curve;
d) continuously measuring real temperature values Cₘ representing the temperature of the region to be heated, using a single temperature sensor;
e) continuing with step b) using the current temperature value Cₘ as the starting temperature value Cₛ if the difference between two successive temperature values Cₘ indicates a normal condition of the temperature sensor; and
f) deactivating the heating if the difference between the two successive temperature values Cₘ indicates a fault condition of the temperature sensor and the virtual temperature Cᵥ exceeds a threshold.

11. The household appliance as recited in claim 10, wherein the household appliance includes a cooktop, and the region to be heated comprises a cooking zone of the cooktop and/or a cooking vessel located on the cooking zone.

12. The household appliance as recited in claim 10, wherein the household appliance includes a cooking chamber which forms the region to be heated.

13. The household appliance as recited in claim 10, wherein:
the single temperature sensor comprises a direct measuring temperature sensor which is located in or adjacent to the region to be heated; or
the single temperature sensor comprises an indirect measuring temperature sensor which is located remotely from the region to be heated.

14. The household appliance as recited in claim 10, wherein the household appliance comprises a cooking appliance which is one or a combination of the following:
a cooktop;
a baking oven;
a microwave oven;
a steam cooker;
a warming drawer.

15. A computer program adapted to perform a method for controlling the heating of a region to be heated of a household appliance when executed on a controller of a household appliance, the method comprising:
a) activating the heating;
b) providing a starting temperature value Cₛ;
c) extrapolating a virtual temperature Cᵥ of the region to be heated over time, beginning from the starting temperature value Cₛ and based on a characteristic heating curve;
d) continuously measuring real temperature values Cₘ representing the temperature of the region to be heated, using a single temperature sensor;
e) continuing with step b) using the current temperature value Cₘ as the starting temperature value Cₛ if the difference between two successive temperature values Cₘ indicates a normal condition of the temperature sensor; and
f) deactivating the heating if the difference between the two successive temperature values Cₘ indicates a fault condition of the temperature sensor and the virtual temperature Cᵥ exceeds a threshold.
